(19) United States
(12) Patent Application Publication
(10) Pub. No.: US 2012/0102207 A1
(43) Pub. Date: Apr. 26, 2012

(54) REGISTRATION OF AD-HOC GROUP MEMBERS INTO AN INFRASTRUCTURE NETWORK

(76) Inventors: Joseph SALOWEY, Seattle, WA (US); Brian Hart, Sunnyvale, CA (US)

(21) Appl. No.: 12/912,039

(22) Filed: Oct. 26, 2010

(51) Int. Cl. G06F 15/16

(52) U.S. Cl. 709/228

(57) ABSTRACT

In an example embodiment, a technique employing a device (registration assistant) that can communicate with an infrastructure network to configure devices via an ad hoc network to communicate with the infrastructure network. An ad hoc device associates with the registration assistant and sends a request to be configured. The registration assistant contacts a registration service on the infrastructure network and sends data identifying the ad hoc device to the registration service. The registration assistant upon receiving a registration response from the registration assistant forwards configuration data to the ad hoc device that can enable the ad hoc device to communicate with the infrastructure network.

### TECHNICAL FIELD

The present disclosure relates generally to ad hoc networking devices.

### BACKGROUND

Ad hoc networking is a popular way to connect devices. In these networks, group members typically create secure associations with one another based upon proximity or some other weak criteria. In some cases, it may be desirable to allow an ad hoc networked device to participate in an enterprise networking environment. Some examples of these types of devices are a printer or a smartphone.

### BRIEF DESCRIPTION OF THE DRAWINGS

The accompanying drawings incorporated herein and forming a part of the specification illustrate the example embodiments.

FIG. 1 illustrates an example topology for employing configuring an ad hoc network device to communicate with an infrastructure network.

FIG. 2 illustrates an example of an apparatus for implementing an example embodiment.

FIG. 3 illustrates an example of a device configured to register ad hoc networking devices with separate transceivers for the ad hoc and infrastructure networks.

FIG. 4 is an example of an apparatus suitable for implementing a registration server.

FIG. 5 is an example of a computer system upon which an example embodiment may be implemented.

FIG. 6 is a block diagram illustrating an example methodology for registering an ad hoc device with an infrastructure network.

FIG. 7 is an example signal diagram illustrating an example of setting up a group owner as an Assisted Enterprise Registration (AER) assistant.

FIG. 8 is an example signal diagram illustrating an example of initial communications between an ad hoc group member and an Assisted Enterprise Registration assistant.

FIG. 9 is an example signal diagram illustrating an example of an Assisted Enterprise Registration assistant registering an ad hoc group member with a registration service on an infrastructure network.

FIG. 10 is an example signal diagram illustrating an example of an Assisted Enterprise Registration assistant device provisioning an ad hoc device.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising: at least one transceiver that communicates with a first network and with a second network; and control logic coupled to the at least one transceiver that sends and receives data via the at least one transceiver. The control logic establishes a secure communication session with a registration service coupled with the first network. The control logic receives data to configure a device via the second network. The control logic receives a configuration request from the device via the second network. The control logic obtains registration data from the device via the second network and sends the registration data to the registration service via the first network. The control logic receives a registration status and registration credentials from the registration service via the first network. The control logic sends a registration result to the device via the second network, the registration result comprises the registration status, registration credentials, and configuration data.

In accordance with an example embodiment, there is disclosed herein an apparatus comprising a transceiver and control logic coupled with the transceiver that sends and receives data via the transceiver. The control logic searches for a device advertising a predefined registration protocol coupled with the transceiver. The control logic sends a request to register with an infrastructure network to a device advertising the predefined registration protocol. The control logic receives a registration result from the device advertising the predefined registration protocol via the transceiver, the registration result comprises registration status data, registration configuration data and registration credentials. The control logic associates with the infrastructure network via the transceiver with the registration credentials received from the device advertising the predefined registration protocol.

In accordance with an example embodiment, there is disclosed herein method comprising associating with a device employing a first protocol on a first network. A request is received to configure the device. Device identification data is obtained device identification data from the device that is sent to a registration service on a second network. A registration response is received from the registration service, and the device is provisioned with data enabling the device to establish communications on the second network responsive to receiving the registration response.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Described in an example embodiment herein is a technique to securely associate an ad-hoc group member to an infrastructure network. Components to achieve this may include but are not limited to 1) an ad hoc network, 2) an ad hoc member, 3) a registration assistant, 4) an infrastructure network, and 5) a registration service.

The ad hoc network, is a network that is not part of the managed enterprise infrastructure. For example the ad hoc network may be a PAN (Personal Area network) or any type of informal, temporary network, such as a WiFi Direct network. An ad hoc member is a member of an ad-hoc network that can securely communicate with other members of the ad-hoc network. The registration assistant is defined as an ad-hoc member that can associate with the infrastructure network and has been delegated special privilege to add devices to the network. For example this could be a WiFi Direct group owner, or a WiFi Direct client. The Infrastructure network is a network managed by the enterprise. The registration assistant is a member of the infrastructure network. The registration service is service that registers ad-hoc member into the infrastructure. It may reside on a controller, MSE (Mobility Services Engine) or AAA (Authentication, Authorization and Accounting) server.

An administrator specifically grants the user and/or device the capability to register ad-hoc devices into the network. This participant will have the capability to be a registration assistant. The registration assistant may have the capability to register all or some predefined devices types with the infrastructure network.

The registration assistant associates securely with the infrastructure network. Once the device is authenticated and authorized it will be provisioned with the necessary data to register ad-hoc group members into the network. This data may include location of registration service, registration procedure, additional credentials, etc. The registration assistant may remain associated with the network or it may disassociate from the infrastructure network.

The registration assistant may now associate an ad-hoc device. This may be through a new security association or a previously established security association. In an example embodiment, the ad-hoc device indicates that it supports “assisted enterprise registration” during the association process.

The registration assistant may now initiate the registration process. The process may be initiated automatically based on policy which determines what devices can be registered. The process may be initiated manually by a user who interacts with a UI (User Interface) on the registration assistant device. The user may query or be notified that a device is available for registration. The registration assistant initiates the registration process by collecting information from the device over a secure pairwise connection. In a particular embodiment, the ad-hoc member has a public key certificate installed at manufacturing time that provides a unique identity for the device and identifies the device manufacturer and type of device. The registration assistant verifies proof of possession of the private key associated with the certificate and check that the device type and identity are consistent with the type of device to be registered. If the device does not have a Manufacturing installed certificate, the registration assistant collects device type and identity information from the device. Once the information is collected (such as a certificate request if it does not already have a certificate) the ad-hoc device is told to wait for more instructions (the device may continue with its regular operation while waiting). The information collected may be augmented by other information obtained by the registration assistant either from a user or other means.

Once the registration assistant collects the information from the ad hoc device, the registration assistant registers the device with the infrastructure. The registration assistant may maintain simultaneous associations with the ad-hoc net and the infrastructure net or it may disassociate from the ad-hoc and associate with the infrastructure. Once the registration assistant is securely associated with the infrastructure network it sends messages to the registration service to inform the registration service of the identity and type of device, which may be stored in an authentication credential (such as manufacturing certificate). In particular embodiments the registration assistant may communicate other information about the device. The communication from the registration assistant may use L2, L3, or application layer protocols.

The registration service authenticates and authorizes the registration assistant. The registration service checks the registration request from the registration assistant and makes sure it is consistent with policy for what the registration assistant can register. If the registration is permitted, the registration server records the registration in an authentication or authorization database. The registration service may issue enterprise credentials to the ad hoc member (e.g. a certificate, an EAP-fast PAC (Extensible Authentication Protocol Fast Protected Access Credential)). This status of the registration and credentials are returned to the registration assistant. The registration assistant communicates the registration status and credentials to the ad-hoc member. The registration assistant may also communicate configuration information necessary for the ad-hoc member to securely associate with the infrastructure. The registration assistant may have to associate with the group member to communicate the registration status and/or credentials; however, the registration assistant is not required to be associated with the infrastructure at this point.

The ad-hoc member now has authorized credentials to associate securely with the enterprise infrastructure using WPA2 (WiFi Protected Access) enterprise. The enterprise infrastructure may treat these credentials under authorization specific to the type of device registered and may take into account that the device is an ad-hoc device and apply additional security and monitoring. Once the ad-hoc device is registered it may restrict its operation to infrastructure only mode until it is manually reset.

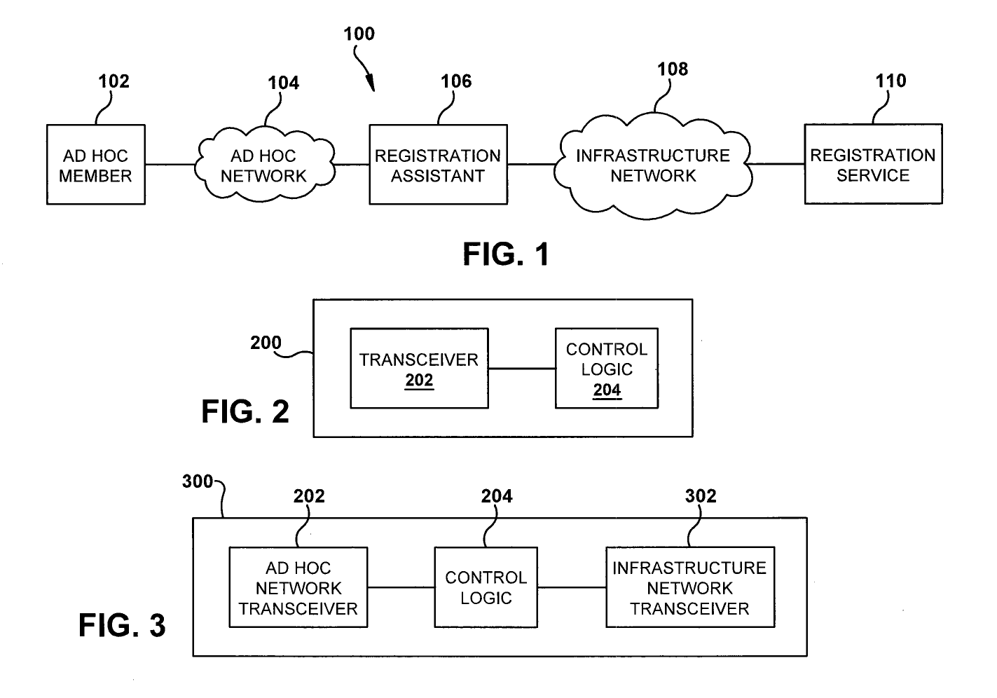

FIG. 1 illustrates an example topology 100 for employing configuring an ad hoc network device 102 to communicate with an infrastructure network 108. In the illustrated example, registration assistant 106 is capable of communicating with ad hoc member 102 over an ad hoc network such as a personal area network (PAN), e.g., WiFi Direct, or other suitable networking topology, and registration assistant 106 is further capable of communicating on an infrastructure network 108.

In an example embodiment, registration assistant 106 communicates with registration service 110 via infrastructure network 108. In particular embodiments, registration assistant 106 may communicate with an access point (AP), not shown, to gain access to infrastructure network 108. In an embodiment, where the registration assistant 106 accesses infrastructure network 108 via an AP, the registration assistant may associate with the AP. In an example embodiment, registration assistant 106 employs WiFi Protect Access (WPA) or WiFi Protected Access 2 (WPA2) to associate with an AP disposed on infrastructure network 108. Registration assistant 108 may receive data from the AP indicating the availability of registration service 110. Registration service 110 may be implemented on any infrastructure node, such as a dedicated server and/or be co-located with other devices such as an AP. registration assistant 106 communicates with registration service 110 to obtain a Assisted Enterprise Registration (AER) policy for the network as well as configuration data.

Upon receiving the policy and configuration data, registration assistant 106 stores the policy and configuration data. Registration assistant 106 may disassociate from infrastructure network 108, or optionally, remain associated with infrastructure network 108.

In an example embodiment, upon receiving the policy and configuration data, registration assistant 106 advertises the ability to provide a registration service. Ad hoc member 102 while communicating with registration assistant 106 via ad hoc network 104 can indicate that ad hoc member 102 supports Assisted Enterprise Registration. Ad hoc member 102 and registration assistant 106 may be associated via ad hoc network 104 using a WiFi Protected Setup (WPS)/WPA2 association or through the use of manufacturing installed certificates. Registration assistant 106 queries the ad hoc member 102 for registration information. Ad hoc member 102 provides the requested data to ad hoc group member 106. Registration assistant 106 may instruct ad hoc group member to wait for the registration result. Registration assistant may remain associated with ad hoc member 102 or may disassociate with ad hoc group member 102.

Registration assistant 108 contacts registration service 110 to register ad hoc member 102. If registration assistant is not associated with infrastructure network 108, a new association may be established. Registration assistant sends ad hoc member 102's registration information to registration service 110. Registration service 110 may authenticate the registration assistant and verify that registration assistant 106 is authorized to perform the registration and/or determine whether registration assistant 106 is authorized to register the type of device of ad hoc member 102. Registration service 110 may generate credentials for ad hoc member 102. The authorization for ad hoc member 102 may be customized based on the device type of ad hoc member 102. Registration service 110 sends a registration status with credentials, if registration is authorized, for ad hoc member 102 to registration assistant 106. Registration assistant 106 may remain associated with infrastructure network 108, or in an example embodiment, registration assistant may disassociate from infrastructure network 108.

Upon receiving the registration status and credentials from registration service 110, registration assistant 106 is able to provision ad hoc member 102. If there currently is no association between ad hoc member 102 and registration assistant 106, a new, secure, session is established. Registration assistant 106 sends registration status, configuration data, and credentials to ad hoc group member 102. Ad hoc member 102 and or registration assistant 106 may, optionally, remain associated after ad hoc member 102 is provisioned with registration status, configuration data and credentials.

Upon being provisioned, ad hoc member 102 may now establish a connection with infrastructure network 108. For example, ad hoc member 102 may be able to associate with an AP coupled with infrastructure network 108. In an example embodiment, ad hoc member 102 establishes a WiFi Protected Access Enterprise Connection (WPA2-ENT) with infrastructure network 108.

FIG. 2 illustrates an example of an apparatus 200 for implementing an example embodiment. Apparatus 200 is suitable for implementing ad hoc member 102 (FIG. 1) and/or registration assistant 106 (FIG. 1). Apparatus 200 comprises a transceiver 202 to enable communication with external devices and control logic 204 coupled with transceiver 202. Transceiver 202 may employ any suitable wired or wireless protocol for communicating with external devices. Control logic 204 is can send and receive data via transceiver 202. Control logic 204 suitably comprises logic for performing the functionality described herein. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In an example embodiment, control logic 204 establishes a secure communication session with a registration service coupled with a first network. Control logic 204 receives data to configure a device via a second network and/or networking protocol. For example, control logic 204 may connect to a registration service (such as registration service 110 in FIG. 1) via an first network (such as infrastructure network 108 in FIG. 1) to receive data to provision a device (such as ad hoc group member 102 in FIG. 1) with data enabling the device to communicate with the first network (such as infrastructure network 108 in FIG. 1).

In an example embodiment, after obtaining the data to configure a device on a second network, control logic 204 receives a configuration request from the device via the second network. In an example embodiment, control logic 204 is still be associated with the first network, and in another example embodiment control logic disassociates with the first network upon receiving the data to configure a device on the second network. Control logic 204 obtains registration data from the device via the second network;, and responsive to receiving the registration data, control logic 204 sends the registration data to the registration service on the first network via transceiver 202. Control logic 204 receives registration status and registration credentials from the registration service on the first network via transceiver 202 and sends the registration result to the device on the second network. In an example embodiment, the registration result comprises the registration status, registration credentials, and configuration data.

In an example embodiment, control logic 204 further comprises a memory. Control logic 204 stores the data to configure a device and policy data in the memory.

In an example embodiment, control logic 204 disassociates with the device on the second network after receiving the registration data from the device to be configured to communicate on the first network. After control logic 204 receives the registration status, configuration data, and credentials, control logic 204 establishes a new, secure session with the device to be configured. Optionally, control logic 204 may signal the device to be configured to wait for a response.

In an example embodiment, control logic 204 disassociates with the first network, coupled with the registration service, after receiving the data to configure a device on the second network. Upon communicating receiving the registration data from the device to be configured on the second network, control logic 204 may initiate a new, secure association with the registration service to provide the registration service with the registration data from the device to be configured.

In an example embodiment, control logic 204 advertises a capability to configure devices coupled with the second network via a predefined registration protocol, e.g., Assisted Enterprise Registration (AER) on the second network. Control logic 204 may receive data from a device on the second network indicating that the device is configurable via the predefined registration protocol.

FIG. 3 illustrates an example of an apparatus 300 that employs separate transceivers 202, 302 for each network. For example, referring to FIG. 1 with continued reference to FIG. 3, transceiver 202 is employed to communicate with the ad hoc or personal area network 104 while transceiver 302 is employed to communicate with infrastructure network 108. Transceiver 202 and transceiver 302 may use different media types. Thus, in this example embodiment, control logic 204 employs transceiver 202 to communicate with the device being configured and employs transceiver 302 to communicate with the registration service as described herein.

In an example embodiment, apparatus 200 may also be employed to implement ad hoc group member 102 in FIG. 1. In this embodiment, control logic 204 searches for a device advertising a predefined registration protocol, such as AER, communicating with transceiver 202. Control logic 204 sends a request to register with an infrastructure network to a device advertising the predefined registration protocol. Control logic 204 receives a registration result from the device advertising the predefined registration protocol via transceiver 202. In an example embodiment, the registration result comprises registration status data, registration configuration data and registration credentials. Control logic 204 associates with the infrastructure network via transceiver 202 with the registration credentials received from the device advertising the predefined registration protocol.

In an example embodiment, control logic 204 sends data indicating compatibility with the predefined registration protocol to the device advertising the predefined registration protocol via the transceiver. The data may be a separate signal or incorporated into a predefined signal such as a probe request. In particular embodiments, the predefined registration protocol is Wi-Fi assisted registration or another WiFi Protected Access compatible protocol.

In an example embodiment, control logic 204 receives a request for identification data via transceiver 202. Control logic 204 sends device identification data via transceiver 202 in response to the request.

In an example embodiment, control logic 204 receives a message to wait for the registration result. Control logic may opt to disassociate with the device performing the registration or may remain associated. If control logic 204 disassociated with the device providing the registration service, a new, secure association may be instituted to receive the registration result. Control logic 204 may perform other tasks while waiting for a response to the registration request.

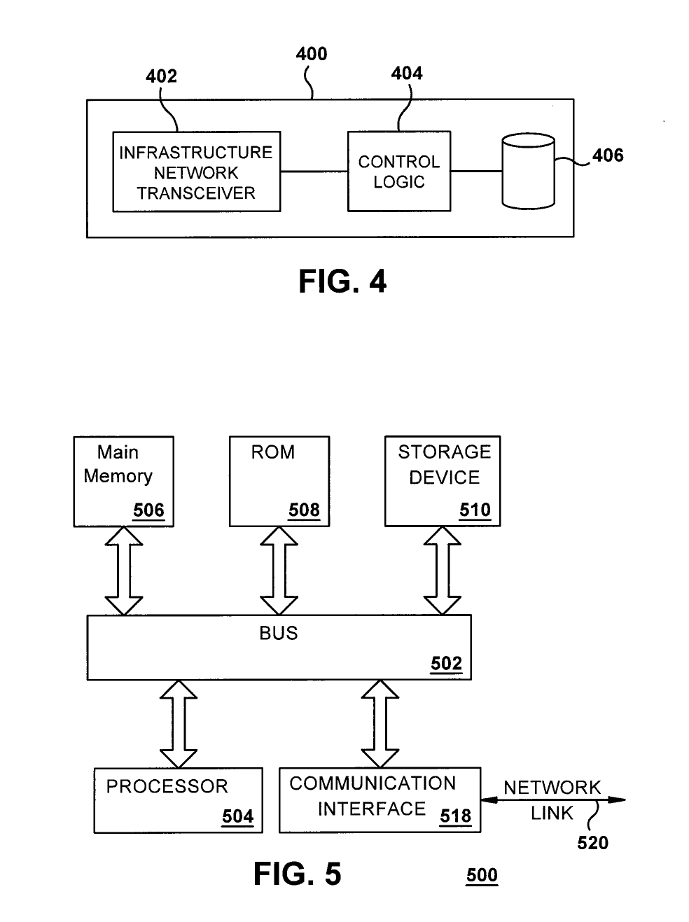

FIG. 4 is an example of an apparatus 400 suitable for implementing a registration server. Apparatus 400 comprises a transceiver 402 suitable for communicating with an infrastructure network, control logic 404 which is operable to send and receive data via transceiver 402, and optionally, a memory 406 for storing data.

In an example embodiment, control logic 404 receives via transceiver 402 a request from a requesting device coupled with the infrastructure network for policy and configuration data in order to perform registrations. In an example embodiment, the request is for Assisted Enterprise Registration (EAR) specific policy and registration. Control logic 404 provides policy and registration data via transceiver 402 to the requesting device. In an example embodiment, control logic 404 may limit the requesting device to configuring predefined types of devices, e.g. printers.

After providing the policy and configuration data, control logic 404 may receive a request from the requesting device to register another device. Control logic 404 verifies that the registration is authorized (for example that the requesting device is authorized to perform registrations and/or is allowed to perform registrations for the type of device being registered). If necessary, control logic 404 generates credentials. Control logic 404 sends a response to the requesting device. The response may suitably comprise a registration status and/or credentials.

FIG. 5 is an example of a computer system 500 upon which an example embodiment may be implemented. Computer system 500 is suitable for implementing the functionality of ad hoc member 102 (FIG. 1), registration assistant 106 (FIG. 1), control logic 204 (FIGS. 3 and 4), and/or control logic 404 described herein.

Computer system 500 includes a bus 502 or other communication mechanism for communicating information and a processor 504 coupled with bus 502 for processing information. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

An aspect of the example embodiment is related to the use of computer system 500 for assisted registration of an ad hoc group member into an infrastructure network. According to an example embodiment, assisted registration of an ad hoc group member into an infrastructure network is provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 504 for execution. Such a medium may take many forms, including but not limited to non-volatile media, and volatile media. Non-volatile media include for example optical or magnetic disks, such as storage device 510. Volatile media include dynamic memory such as main memory 506. 5As used herein, tangible media may include volatile and non-volatile media. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 504 for execution. For example, the instructions may initially be borne on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506 from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling computer system 500 to a network link 520 that is connected to a local network (not shown)522. For example, communication interface 518 may be a local area network (LAN) card to provide a data communication connection to a compatible LAN. As another example, communication interface 518 may be an integrated services digital network (ISDN) card or a modem to provide a data communication connection to a corresponding type of telephone line. Wireless links may also be implemented. In any such implementation, communication interface 518 sends and receives electrical, electromagnetic, or optical signals that carry digital data streams representing various types of information.

Computer system 500 can send messages and receive data, including program codes, through network(s), coupled with communication interface 518. For example, a server (not shown) might transmit a requested code for an application program through a network and communication interlace 518. In accordance with an example embodiment, one such downloaded application provides for assisted registration of an ad hoc group member into an infrastructure network as described herein.

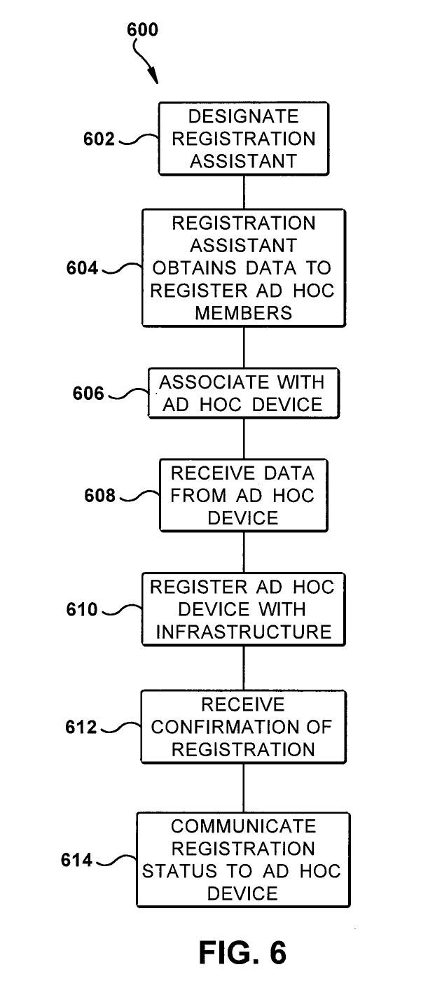

In view of the foregoing structural and functional features described above, a methodology 600 in accordance with an example embodiment will be better appreciated with reference to FIG. 6. While, for purposes of simplicity of explanation, methodology 600 of FIG. 6 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement methodology 600 in accordance with an example embodiment. Methodology 600 described herein is suitably adapted to be implemented in hardware, software, or a combination thereof. For example, methodology 600 may be embodied in a non-transitory computer readable medium and perform the functionality described herein when executed by a processor such as processor 504 in FIG. 5.

At 602, an administrator specifically grants a user and/or device (which may be referred to herein as a Assisted Enterprise Registration or “AER” assistant) the capability to register ad-hoc devices into the network. The AER assistant will have the capability to be a member or a group owner of the ad-hoc group. The AER assistant may have the capability to register all or some devices types with the infrastructure network.

At 604, the AER assistant associates securely with the infrastructure network. Once the AER assistant is authenticated and authorized with the infrastructure network, it will be provisioned with the necessary data to register ad-hoc group members into the network. This data may include location of registration service, registration procedure, additional credentials, etc. The AER assistant may remain associated with the network or it may disassociate from the infrastructure network.

At 606, the AER assistant may now associate an ad-hoc device. This may be through a new security association or a previously established security association. In an example embodiment, the ad-hoc device indicates that it supports “assisted enterprise registration” during the association process.

At 608, the AER assistant may initiate the registration process. The process may be initiated automatically based on policy which determines what devices can be registered. The process may be initiated manually by a user who interacts with a UI (User Interface) on the registration assistant device. The user may query or be notified that a device is available for registration. The AER assistant initiates the registration process by collecting information from the device over a secure pairwise connection. In a particular embodiment, the ad-hoc member has a public key certificate installed at manufacturing time that provides a unique identity for the device and identifies the device manufacturer and type of device. The AER assistant verifies proof of possession of the private key associated with the certificate and check that the device type and identity are consistent with the type of device to be registered. If the device does not have a Manufacturing Installed Certificate, the AER assistant collects device type and identity information from the device. Once the information is collected (such as a certificate request if it does not already have a certificate) the ad-hoc device is told to wait for more instructions (the device may continue with its regular operation while waiting). The information collected may be augmented by other information obtained by the registration assistant either from a user or other means.

Once the AER assistant collects the information from the ad hoc device, at 610, the AER assistant registers the device with the infrastructure. The AER assistant may maintain simultaneous associations with the ad-hoc net and the infrastructure net or it may disassociate from the ad-hoc and associate with the infrastructure. Once the AER assistant is securely associated with the infrastructure network it sends messages to the registration service to inform the registration service of the identity and type of device, enterprise credential (such as manufacturing certificate). In particular embodiments the AER assistant may communicate other information about the device. The communication from the AER assistant may use L2, L3 or application layer protocols.

In an example embodiment, the registration service authenticates and authorizes the AER assistant. The registration service checks the registration request from the AER assistant and makes sure it is consistent with policy for what the AER assistant can register. If the registration is permitted, the registration server records the registration in an authentication or authorization database. The registration service may issue enterprise credentials to the ad hoc member (e.g. a certificate, a EAP-fast PAC (Extensible Authentication Protocol Fast Protected Access Credential)). This status of the registration and credentials are returned to the AER assistant at 612. At 614, the AER assistant communicates the registration status and credentials to the ad-hoc member. The AER assistant may have to associate with the group member to communicate the registration status and/or credentials; however, the AER assistant is not required to be associated with the infrastructure at this point.

The ad-hoc member now has authorized credentials to associate securely with the enterprise infrastructure using WPA2 (WiFi Protected Access) enterprise. The enterprise infrastructure may treat these credentials under authorization specific to the type of device registered and may take into account that the device is an ad-hoc device and apply additional security and monitoring. Once the ad-hoc device is registered it may restrict its operation to infrastructure only mode until it is manually reset.

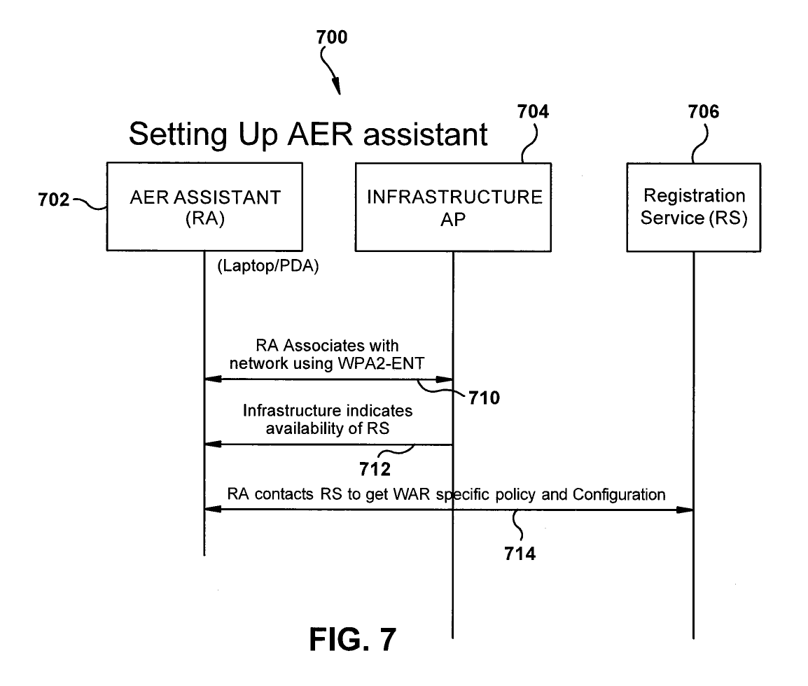

FIGS. 7-10 illustrate an example where an ad hoc group member, possibly designated a group owner, is setup to provide Assisted Enterprise Registration (AER), and provisions ad hoc group members to communicate with an infrastructure network. Although the example in FIGS. 7-10 describe Assisted Enterprise Registration, those skilled in the art can readily appreciate that the principles described herein are suitably adaptable other protocols.

FIG. 7 is an example signal diagram 700 illustrating an example of setting up an ad hoc group member as a Assisted Enterprise Registration assistant. The Assisted Enterprise Registration (AER) assistant (RA) 702 is selected. The selection may be made by an administrator who may enter data indicating the selection via an interface associated with AER assistant 702. The AER assistant may be any suitable device such as a laptop computer or personal digital assistant (PDA).

As illustrated by 710, the RA assistant associates with an infrastructure AP 704. The association may use any suitable protocol such as WPA2-ENT (WiFi Protected Access ver. 2, Enterprise). As illustrated by 712, infrastructure AP 704 advertises the availability of a registration service (RS). Infrastructure AP 704 may indicate this feature at any time, e.g., before, during and/or after association. RA 702 contacts the registration service 706 to obtain the AER specific policy and configuration data as indicated by 714. RA 702 caches the policy and configuration data and is now capable of configuring ad hoc devices to communicate with the infrastructure network. At this point, RA 702 may disassociate from the infrastructure network; however, in some embodiments RA 702 remains associated with the infrastructure network.

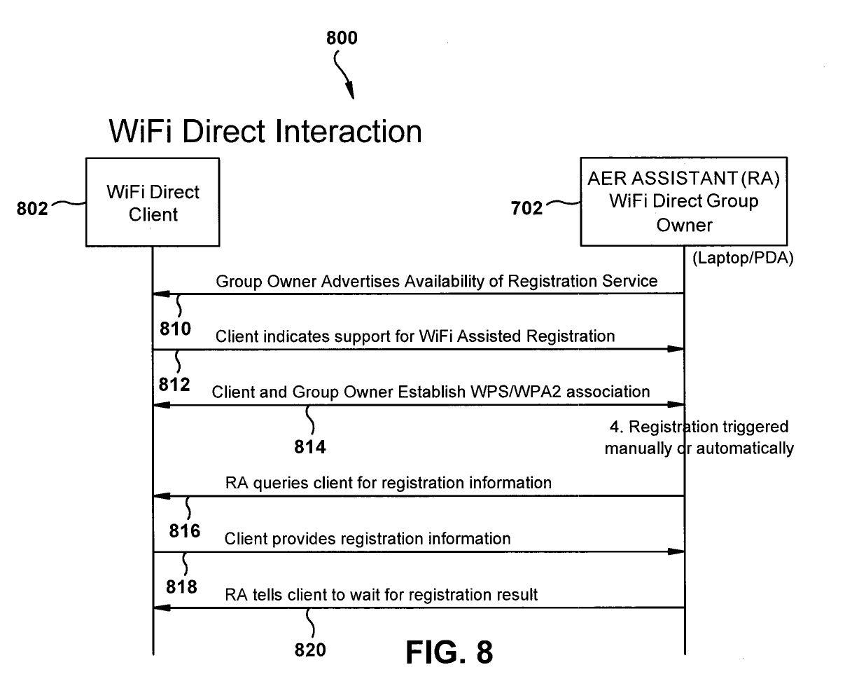

FIG. 8 is an example signal diagram 800 illustrating an example of initial communications between an ad hoc group member 802 and a Assisted Enterprise Registration assistant (RA) 702. In this example, ad hoc group member 802 is a WiFi Direct client, although the principles described herein are suitable for use with other protocols. In the illustrated example, RA 702 advertises the availability of the registration service as represented by 810. Ad hoc group member 802 indicates support for WiFi assisted registration to RA 702 as represented by 812. Ad hoc group member 802 and RA 702 associate as represented by 814. In an example embodiment, the association is a WPS/WPA2 association established via Wi-Fi Protected Setup (WPS). Note that although 810, 812, 814 appear as separate elements, in an example embodiment these may be combined. For example, during the association process ad hoc group member 802 may indicate support for assisted enterprise registration and RA 702 may advertise the ability of the registration service. Moreover, elements 810, 812, 814 may appear in different order. For example, the ad hoc group member 802 and RA 702 may first associate as represented by 814, ad hoc group member 802 may indicate it supports assisted enterprise registration as represented by 812 and RA 702 may advertise the ability of the registration service as represented by 810.

The registration process may be triggered automatically or manually. For example, RA 702 may initiate the process as soon as RA 702 and ad hoc group member 802 are associated, or RA 702 may wait until ad hoc group member sends a signal requesting the registration service.

RA 702 queries ad hoc group member 802 for registration information as represented by 816. Ad hoc group member 802 responds with the registration information as represented by 818. Optionally, RA 702 may instruct ad hoc group member 802 to wait for the registration result as represented by 820. Ad hoc group member 802 may remain associated with RA 702 or may disassociate with RA 702 while RA 702 registers ad hoc group member 802.

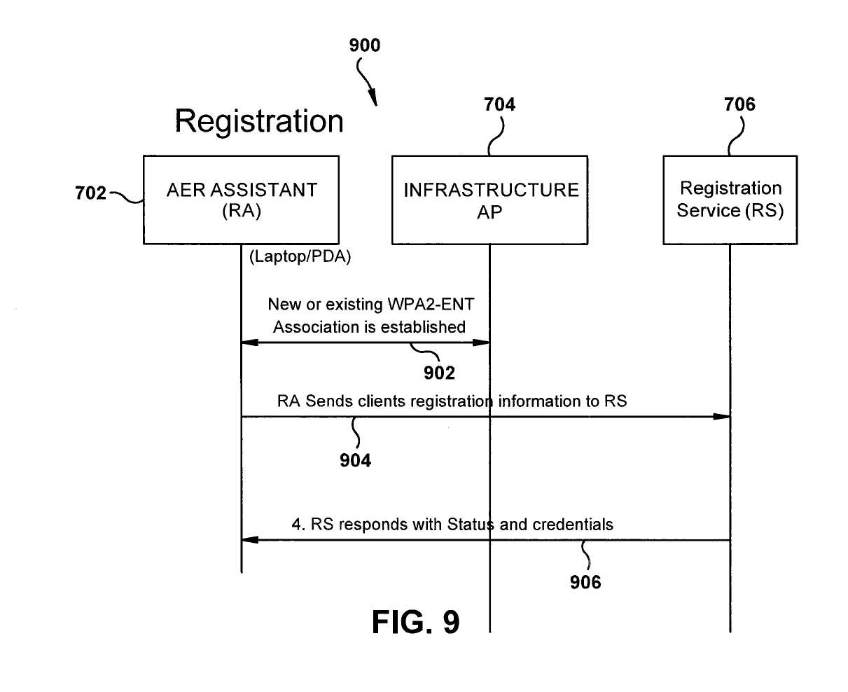

FIG. 9 is an example signal diagram 900 illustrating an example of a Assisted Enterprise Registration device registering an ad hoc group member with registration service 706 on an infrastructure network. RA 702 may employ a current association with infrastructure AP 704 or may initiate a new, secure association as represented by 902. In an example embodiment, the association between RA 702 and infrastructure AP 704 is a WPA2-ENT association.

RA 702 sends registration information for ad hoc group member 802 to registration service 706 as represented by 904. In an example embodiment, registration service 706 makes sure that RA 702 is authorized and/or that the registration of ad hoc group member 802 (FIG. 8) is authorized. If needed, registration service 706 generates credentials for ad hoc group member 802. The authorization for ad hoc group member 802 may be customized depending on device type, or any other suitable criteria. The registration service sends the registration status and credentials for ad hoc group member 802 (FIG. 8) to RA 702 as illustrated by 906. Upon receiving the registration status and credentials from registration service 706, RA 702 may disassociate from the infrastructure network.

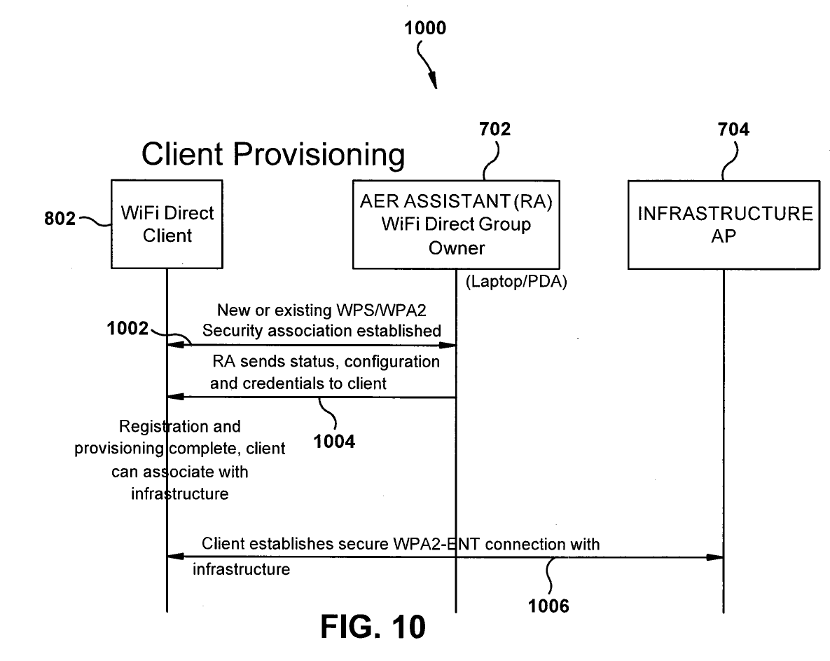

FIG. 10 is an example signal diagram 1000 illustrating an example of a Assisted Enterprise Registration device provisioning an ad hoc device. Ad hoc group member 802 and RA 702 may employ a previous association or initiate a new association as represented by 1002. In an example embodiment, the association between RA 702 and ad hoc group member 802 is a WPS/WPA2 security association.

RA 702 sends registration status, registration configuration, and registration credentials to ad hoc group member 802 as indicated by 1004. Ad hoc group member 802 may disassociate from RA 702 upon receipt of the registration status, registration configuration and registration credentials.

Registration and provisioning is now complete and ad hoc group member 802 can now associate with the infrastructure network. As illustrated by 1006, ad hoc group member 802 may establish a secure WPA2-ENT connection with the infrastructure network via infrastructure AP 704 (or the connection may be with another AP associated with the infrastructure network).

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
at least one transceiver that is configured to communicate with a first network and with a second network; and
control logic coupled to the at least one transceiver that sends and receives data via the at least one transceiver;
wherein the control logic establishes a secure communication session with a registration service coupled with the first network;
wherein the control logic receives data to configure a device via the second network;
wherein the control logic receives a configuration request from the device via the second network;
wherein the control logic obtains registration data from the device via the second network;
wherein the control logic sends the registration data to the registration service via the first network;
wherein the control logic receives a registration status and registration credentials from the registration service via the first network; and
wherein the control logic sends a registration result to the device via the second network, the registration result comprises the registration status, registration credentials, and configuration data.

2. The apparatus of claim 1, further comprising a memory; and
wherein the control logic stores the data to configure a device and policy data in the memory.

3. The apparatus of claim 1, wherein the control logic disassociates with the first network responsive to receiving the data to configure the device via the second network.

4. The apparatus of claim 3, wherein the control logic associates with the first network a second time responsive to receiving the configuration request from the device via the second network.

5. The apparatus of claim 1, wherein the control logic advertises a capability to configure devices coupled with the second network via a predefined registration protocol on the second network.

6. The apparatus of claim 5, wherein the control logic receives data from the device indicating the device is configurable via the predefined registration protocol.

7. The apparatus of claim 6, wherein the predefined registration protocol is a WiFi Protected Access compatible protocol.

8. The apparatus of claim 1, wherein the control logic signals the device to wait for the registration result responsive to obtaining the registration data.

9. The apparatus of claim 8, wherein the control logic disassociates with the device disassociate while the device is waiting for the registration result.

10. The apparatus of claim 9, wherein the control logic associates with the device a second time responsive to receiving the registration status and registration credentials from the registration service via the first network prior to sending the registration result to the device via the second network.

11. The apparatus of claim 1, wherein the at least one transceiver comprises a first transceiver for communicating with the first network and a second transceiver for communicating on the second network.

12. An apparatus, comprising:
a transceiver; and
control logic coupled with the transceiver that sends and receives data via the transceiver;
wherein the control logic searches for a device advertising a predefined registration protocol coupled with the transceiver;
wherein the control logic sends a request to register with an infrastructure network to a device advertising the predefined registration protocol;
wherein the control logic receives a registration result from the device advertising the predefined registration protocol via the transceiver, the registration result comprises registration status data, registration configuration data and registration credentials; and
wherein the control logic associates with the infrastructure network via the transceiver with the registration credentials received from the device advertising the predefined registration protocol.

13. The apparatus of claim 12, wherein the control logic sends data indicating compatibility with the predefined registration protocol to the device advertising the predefined registration protocol via the transceiver.

14. The apparatus of claim 12, wherein the control logic associates with the device advertising the predefined registration protocol with a WiFi Protected Access compatible protocol.

15. The apparatus of claim 12, wherein the control logic receives a request for data identifying a device via the transceiver; and
wherein the control logic sends device identification data via the transceiver response to the request for data identifying a device.

16. The apparatus of claim 12, wherein the control logic receives a message to wait for the registration result.

17. The apparatus of claim 16, wherein the control logic disassociates with the device advertising the predefined registration protocol responsive to receiving the message to wait for the registration result.

18. The apparatus of claim 16, wherein the control logic establishes a new secure session with the device advertising the predefined registration protocol to receive the registration result.

19. A method, comprising:
associating with a device employing a first protocol on a first network;
receiving a request to configure the device;
obtaining device identification data from the device;
sending the device identification data to a registration service on a second network;
receiving a registration response from the registration service; and
provisioning the device with data enabling the device to establish communications on the second network.

20. The method of claim 20, further comprising:
disassociating with the device responsive to obtaining device identification data from the device;
securely associating with the registration service responsive to obtaining device identification data from the device; and
establishing a new, secure session with the device responsive to receiving the registration response.
